(19) United States
(12) Patent Application Publication
(10) Pub. No.: US 2022/0335511 A1
(43) Pub. Date: Oct. 20, 2022

(54) SYSTEMS AND METHODS FOR COLLABORATIVE SHOPPING

(71) Applicant: Walmart Apollo, LLC, Bentonville, AR (US)

(72) Inventors: Ramandeep Singh, Bengaluru (IN); Deepak Mandya Chandranath, Bangalore (IN); Venkata Janendra Pachigolla, Bangalore (IN); Chandresh Bhardwaj, Bangalore (IN)

(21) Appl. No.: 17/725,378

(22) Filed: Apr. 20, 2022

Related U.S. Application Data
(60) Provisional application No. 63/177,001, filed on Apr. 20, 2021.

(51) Int. Cl. G06Q 30/06; G06T 15/20; G06T 19/20; G06T 19/00; G06T 7/11; G06V 20/20; G06V 10/70; H04N 7/14

(52) U.S. Cl. CPC G06Q 30/0643; G06T 15/205; G06T 19/20; G06T 19/006; G06T 7/11; G06V 20/20; G06V 10/70; H04N 7/147; G06T 2215/16; G06T 2219/024; G06T 2219/2012; G06T 2207/20081

(57) ABSTRACT

In some embodiments, a system for collaborative shopping comprises an application configured to be executed on mobile devices, the application when executed by a first mobile device causes the first mobile device to perform operations comprising capturing an image of a product display unit, the application when executed by a second mobile device causes the second mobile device to perform operations comprising receiving the image of the product display unit, receiving user input identifying a selected product, generating a second mobile device augmented reality presentation, presenting the second mobile device augmented reality presentation, and transmitting an indication of the selected product, wherein the application when executed by the first mobile device causes the first mobile device to perform operations further comprising receiving the indication of the selected product, identifying the selected product from within the image of the product display unit, and generating a first mobile device augmented reality presentation.

### RELATED APPLICATIONS

This application claims the benefit of U.S. Provisional Application No. 63/177,001, filed Apr. 20, 2021, which is incorporated herein by reference in its entirety.

### TECHNICAL FIELD

This invention relates generally to mobile devices and, more specifically, shopping with mobile devices.

### BACKGROUND

Many people enjoy shopping collaboratively. For example, a person and that person's partner may enjoy shopping collaboratively for a present for their child. Typically, collaborative shopping requires multiple people (i.e., the person and the partner in this example) to be physically present in a retail facility. Unfortunately, due to scheduling or other constraints, it can be difficult for multiple people to arrange a collaborative shopping trip. Accordingly, a need exists for collaborative shopping experiences in which one or more of the people shopping collaboratively can be remote from the retail facility.

### BRIEF DESCRIPTION OF THE DRAWINGS

Disclosed herein are embodiments of systems, apparatuses, and methods pertaining collaborative shopping. This description includes drawings, wherein:

FIGS. 1A-1C depict a first mobile device 102 and a second mobile device 112 presenting augmented reality presentations associated with a collaborative shopping experience, according to some embodiments;

FIG. 2 is a block diagram of a system 200 for an augmented reality collaborative shopping experience, according to some embodiments;

FIG. 3 is a flow chart depicting example operations for an augmented reality collaborative shopping experience, according to some embodiments;

FIG. 4 depicts a mobile device 404 presenting information 408 to a customer while shopping, according to some embodiments;

FIG. 5 is a block diagram of a system 500 for presenting information to customers while shopping, according to some embodiments;

FIG. 6 is a flow chart depicting example operations for presenting information to customers while shopping, according to some embodiments; and

FIG. 7 is a block diagram of an example mobile device 700, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to collaborative shopping. In some embodiments, an augmented reality system for collaborative shopping comprises an application configured to be executed by a first mobile device and a second mobile device, the application when executed by the first mobile device causes the first mobile device to perform operations comprising capturing, via an image capture device of the first mobile device, an image of a product display unit, wherein the image of the product display unit includes one or more products, transmitting, via a communications network, the image of the product display unit, the application when executed by the second mobile device causes the second mobile device to perform operations comprising receiving, via the communications network, the image of the product display unit, receiving, via a user input device of the second mobile device, user input, wherein the user input identifies a selected product, and wherein the selected product is one of the one or more products, generating a second mobile device augmented reality presentation, wherein the second mobile device augmented reality presentation includes the image of the product display unit and a second mobile device marker, wherein the second mobile device marker denotes the selected product in the image of the product display unit, presenting, via a display device, the second mobile device augmented reality presentation, and transmitting, via the communications network, an indication of the selected product, wherein the application when executed by the first mobile device causes the first mobile device to perform operations further comprising receiving, via the communications network, the indication of the selected product, identifying, based on the indication of the selected product, the selected product from within the image of the product display unit, and generating a first mobile device augmented reality presentation, wherein the first mobile device augmented reality presentation includes the image of the product display unit and a first mobile device marker, wherein the first mobile device marker denotes the selected product in the image of the product display unit.

As previously discussed, many people enjoy shopping collaboratively. Specifically, two people shopping for a birthday present for a friend may prefer to shop together to select the birthday present. However, it can be difficult for two or more people to arrange such a collaborative shopping trip. For example, it may be difficult to coordinate schedules, or the two people may live too far from one another to easily conduct such a shopping trip. While the two people can talk on the phone while shopping, a simple phone discussion doesn't allow both people to see the available options and compare the available options. Put simply, a simple conversation on the phone lacks much of the value and enjoyment of an in-person collaborative shopping experience.

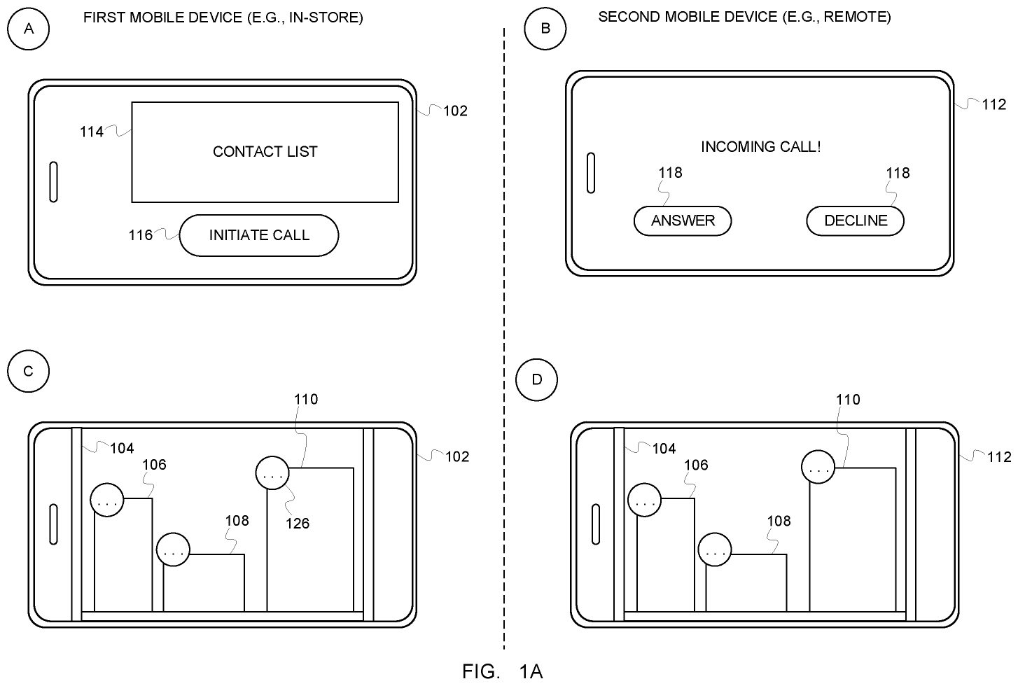

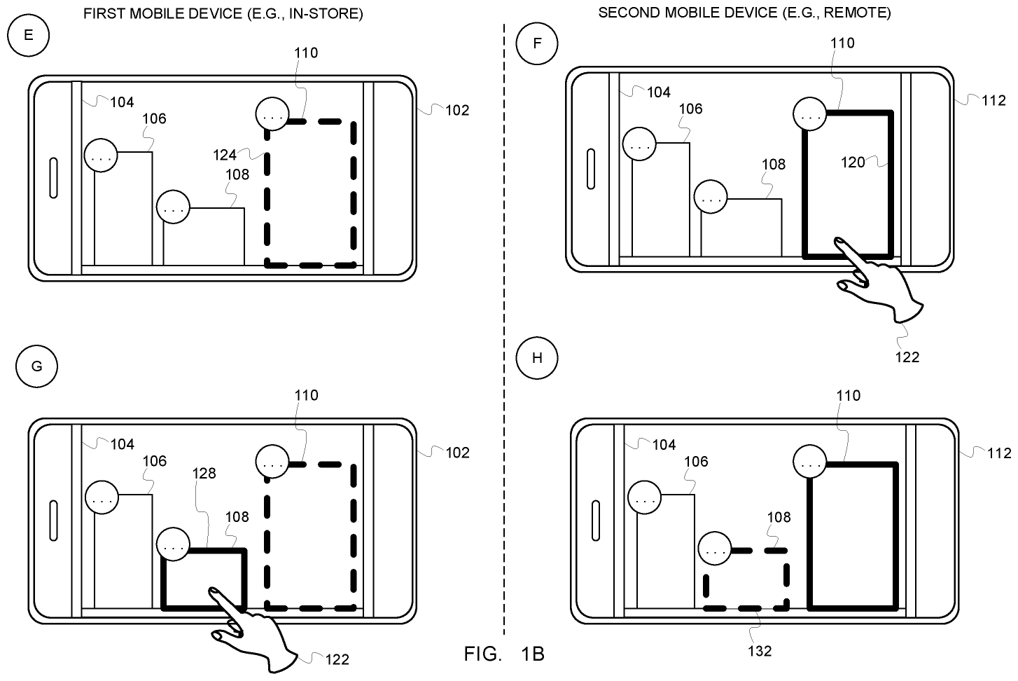

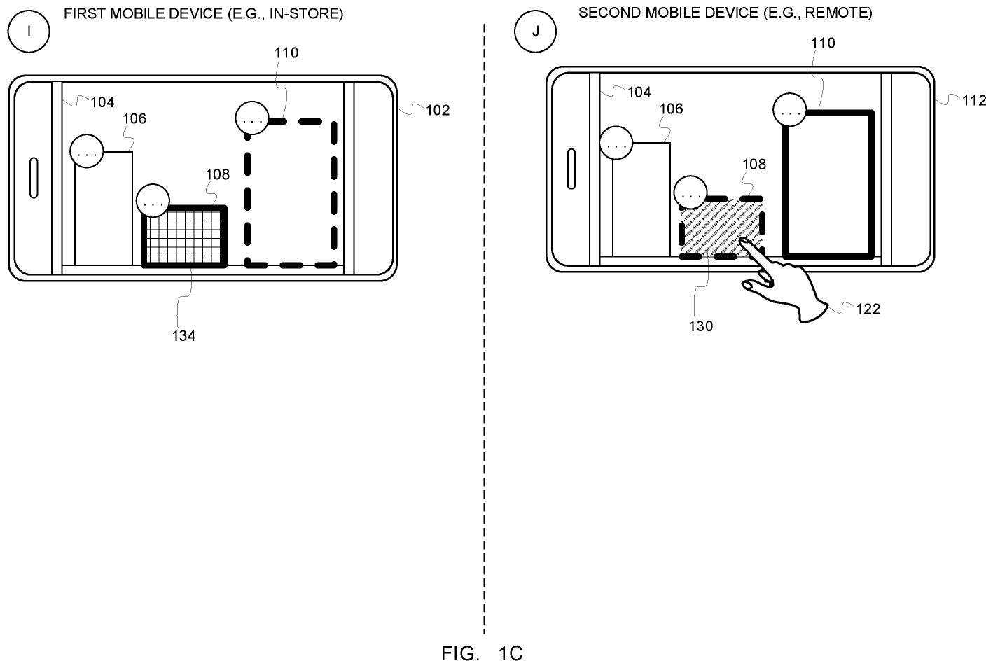

Described herein are systems, methods, and apparatuses that seek to provide an improved collaborative shopping experience when one or more of the people participating in the collaborative shopping experience are not physically present at the retail facility. In one embodiment, both the person in the retail facility and the person who is remote from the retail facility use mobile devices to view augmented reality presentations related to the collaborative shopping experience. In such embodiments, the person in the retail facility can capture images via that person's mobile device and transmit the images to the mobile device of the person who is remote from the retail facility. Further, in some embodiments, one or both of the people can make selections from the augmented reality presentations. The selections are incorporated into the augmented reality presentations such that each of the people can see the selections that the other person is making. The discussion of FIGS. 1A-1C provides an overview of such a collaborative shopping experience.

FIGS. 1A-1C depict a first mobile device 102 and a second mobile device 112 presenting augmented reality presentations associated with a collaborative shopping experience, according to some embodiments. The example operations depicted in FIGS. 1A-1C include operations between the first mobile device 102 and the second mobile device 112. FIGS. 1A-1C depicts operations at stages A-J. The stages are examples and are not necessarily discrete occurrences over time (e.g., the operations of different stages may overlap). Additionally, FIGS. 1A-1C are an overview of example operations. As previously discussed, the collaborative shopping experiences described herein can be utilized when one or more of the collaborative shopping participants are remote from a retail facility (i.e., not physically present at the retail facility). It should be noted that the term “retail facility” is used for ease of readability, and that a location may be a “retail facility” as used herein that is not strictly a retail facility. For example, as used herein, the term “retail facility” encompasses any location in which goods and/or services can be obtained, whether a brick-and-mortar dedicated to shopping (e.g., a store), online, a facility not dedicated to shopping (e.g., a home or yard during a garage sale), etc. Accordingly, though the first mobile device 102 is labeled as “in-store” in FIGS. 1A-1C, the “in-store” designation simply means that the first mobile device 102 is in a location in which goods and/or services can be obtained. While the first mobile device 102 is designated as “in-store,” the second mobile device 112 is designated as “remote.” The “remote” designation means that the second mobile device is not near enough to the first mobile device 102 such that a person in possession of the first mobile device and a person in possession of the second mobile device can easily speak with one another. For example, the second mobile device 112 may be in a different geographic location than the first mobile device 102 (e.g., a different town, city, state, country, etc.). As another example, the first mobile device 102 and the second mobile device 112 may be at the same retail facility, but in different areas of the retail facility such that the people possessing the mobile devices cannot easily communicate. FIGS. 1A-1C are divided into two columns: a left column and a right column. The left column depicts the first mobile device 102 and the right column depicts the second mobile device 112.

At Stage A, a first person (i.e., a person in possession of the first mobile device 102) initiates the collaborative shopping experience via the first mobile device 102. In the example depicted in FIGS. 1A-1C, the collaborative shopping experience is conducted via a video call. Accordingly, the first mobile device 102 presents a user interface from which the first person can initiate the video call. As an example, the user interface can include a contact list 114 and a control 116 to initiate the collaborative shopping experience. The contact list 114 includes contacts of the first person. The first person can select one or more of the contacts from the contact list 114 to include in the collaborative shopping experience. The first person selects the control 116 to initiate the collaborative shopping experience.

At Stage B, the second mobile device 112 presents a notification that a collaborative shopping experience is desired. The second mobile device 112 presents a user interface including buttons 118 that allow a second person (i.e., a person in possession of the second mobile device 112) to accept or decline the call. For this discussion, it is assumed that the second person has selected the button 118 associated with accepting (i.e., answering) the incoming call such that the collaborative shopping experience can occur.

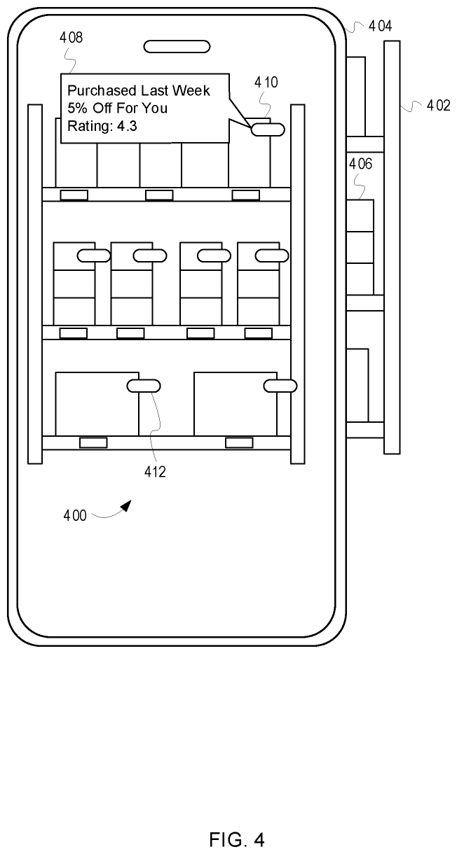

At Stage C, the collaborative shopping experience begins. The collaborative shopping experience is based on images captured via the first mobile device 102. The images can be still images (e.g., digital photographs) and/or video images (e.g., digital video). At Stage C, the first mobile device 102 is presenting the collaborative shopping experience. As depicted at Stage C, the first mobile device 102 has captured an image of a product display unit 104 (i.e., generally an image of products and/or services that can be obtained). The product display unit 104 contains three products: 1) a first product 106, 2) a second product 108, and 3) a third product 110. As depicted in FIGS. 1A-1C, each of the products has an associated selection button 126. In one embodiment, selection of the selection buttons 126 prompt the collaborative shopping experience to present information associated with the products. For example, selection of the selection button 126 associated with the third product 110 will cause the collaborative shopping experience to present information about the third product. Such a process is described in more detail with respect to FIGS. 4-6. At Stage C, no selections have been made with respect to the selection buttons 126 or the products.

At Stage D, the second mobile device 112 is presenting the collaborative shopping experience. At Stage D, no selections have been made with respect to the selection buttons 126 or the products. Accordingly, at Stage D, the collaborative shopping experience includes the image(s) as captured by the first mobile device 102.

At Stages E and F, the second person has made a selection via the second mobile device 112. The selection is indicated by a hand 122 representing selection of the third product 110 by the second person. Selection of the third product 110 causes the collaborative shopping experience to update to include an indication of the selection of the third product 110 by the second person. The indication can include a marker, such as bordering, shading, highlighting, color-coding, etc. As depicted in FIG. 1B, the indication of the selection is a first marker 120 around the third product 110. At Stage E, the collaborative shopping experience presented by the first mobile device 102 is also updated to include an indication of the selection of the third product 110 made via the second mobile device 112. Specifically, the collaborative shopping experience presented by the first mobile device 102 is updated to include a second marker 124 associated with the third product 110. The second marker 124 is a border around the third mobile product 110 as presented on the first mobile device 102. The second marker 124 indicates that the second person has selected the third product 110. In one embodiment, as depicted between Stages E and F, the markers can have different visually distinguishable properties to indicate which person has made the selection. For example, as depicted in Stages E and F, the first marker 120 is a solid border and the second marker 124 is a dashed border. The properties of the markers can differ based on color, style, weight, shading type, etc.

At Stages G and H, the first person has made a selection via the first mobile device 102. The selection is indicated by the hand 122 representing the selection of the second product 108 by the first person. The selection of the second product 108 is indicated by a third marker 128 on the first mobile device 102. When the first person makes the selection of the second product 108 via the first mobile device 102, the collaborative shopping experience for the second person on the second mobile device 112 is updated to indicate this selection. Specifically, as shown as Stage H, the collaborative shopping experience presented by the second mobile device 112 is updated to include a fourth marker 132 indicating the first person's selection of the second product 108. As discussed previously, the properties (e.g., appearance) of the markers can differ between the first mobile device 102 and the second mobile device 112. As depicted in Stages G and H, the third marker 128 is a solid border and the fourth marker 132 is a dashed marker. In the example depicted in FIGS. 1A-1C, the markers differ between the mobile devices, but are consistent to the person who possesses the mobile device. That is, selections made by a person appear consistent to the person (i.e., solid bordering) and selections made by another person appear consistent (i.e., dashed bordering).

In some embodiments, as depicted between FIGS. 1B and 1C, different levels of selection can be provided. For example, the selections made in FIG. 1B can be preliminary selections intended to draw a person's attention to specific products. At Stages I and J, a subsequent selection is shown. In this example, the subsequent selection is made by the second person via the second mobile device 112, as indicated by the hand 122. The subsequent selection is of the second product 108 by the second person. The subsequent selection can indicate, for example, that the second person would like to choose the second product 108. The subsequent selection is indicated by a fifth marker 130. The fifth marker 130 is shading of the second product 108. The collaborative shopping experience presented by the first mobile device is updated to indicate this subsequent selection with a sixth marker 134. The sixth marker 134 is shading of the second product 108 in the collaborative shopping experience presented by the first mobile device 102.

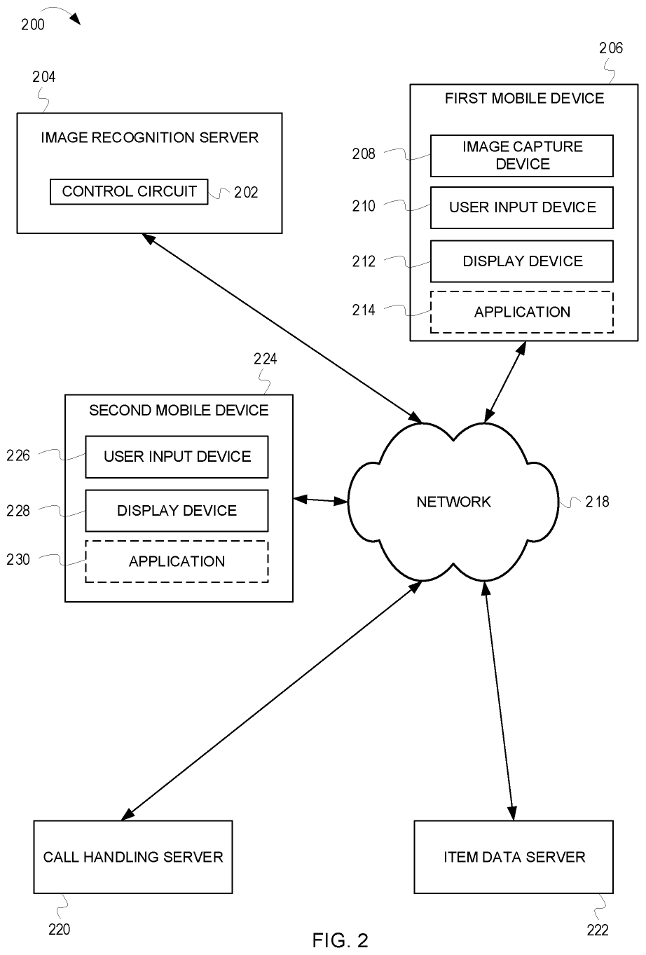

While the discussion of FIGS. 1A-1C provides an overview of a collaborative shopping experience with augmented reality, the discussion of FIG. 2 provides additional detail regarding a system for an augmented reality collaborative shopping experience.

FIG. 2 is a block diagram of a system 200 for an augmented reality collaborative shopping experience, according to some embodiments. The system 200 includes an image recognition server 204, a first mobile device 206, a second mobile device 224, a network 218, a call handling server 220, and an item data server 222. One or more of the image recognition server 204, the first mobile device 206, the second mobile device 224, the personalization server 216, the call handling server 220, and the item data server 222, are communicatively coupled via the network 218. The network 218 can include a local area network (LAN) and/or a wide area network (WAN), such as the Internet. Accordingly, the network 218 can include wired and/or wireless links and transmit and receive communications via any suitable protocol.

The first mobile device 206 and second mobile device 224 can be of any suitable type, such as a smartphone, a tablet, a personal digital assistance (PDA), smartwatch, a laptop computer, a desktop computer, etc. The first mobile device 206 includes an image capture device 208, a user input device 210, and a display device 212. The second mobile device 224 includes a user input device 226 and a display device 228. The first mobile device 206 is an “in-store” mobile device and the second mobile device 224 is a “remote” mobile device. The first mobile device 206 and the second mobile device 224 are configured to execute an application 214, 230 and the application 214, 230 can be stored in a memory of the mobile device and executed by a processor of the first mobile device 206 and/or second mobile device 224 (e.g., as shown in FIG. 4). The application 214, 230 comprises computer program code that is configured to be installed on and executed by the mobile device 206, 224. The application 214, 230 can be executed by the mobile device 206, 224 in concert with other software modules or applications (i.e., computer program code), or groups of applications, such as operating systems, locationing applications (e.g., mapping, GPS, etc. applications), two-factor authentication applications (TFA), single sign on (SSO) applications, graphics processing applications, security applications, etc. In one embodiment, the application 214, 230 is a collaborative shopping application, as described herein. In such embodiments, the application 214, 230 can be a dedicated application (e.g., an application specific to a retailer or to collaborative shopping) or a general purpose application that, while not a “dedicated application,” can perform the functions described herein with respect to collaborative shopping experiences. In some embodiments, the application 214, 230 is an add-on application installed on the mobile device 206, 224 and that cooperates with other application(s) of the mobile device 206, 224, such as the operating system and works with other application(s) to provide the functionality described herein. For example, in the embodiment illustrated in FIG. 2, the application 214 communicates with the operating system of the mobile device 206 to control and receive data from at least the display device 212, the user input device 210, and the image capture device 208. The system 200 can include any desired number of mobile devices. For example, as described with respect to FIGS. 1A-1C, two customers can participate in a collaborative shopping experience via their mobile devices. However, it should be noted that embodiments are not limited to two mobile devices. For example, in some embodiments, three or more customers may participate in a collaborative shopping experience using three or more mobile devices.

The image capture device 208 is configured to capture images, such as images of product display units. The image capture device 208 can be of any suitable type, and include components such as sensors, lens, apertures, etc. The user input device 210, 226 is configured to receive user input from a customer. For example, the user input can select a product from an image, initiate a collaborative shopping experience, select guests for the collaborative shopping experience, etc. Accordingly, the user input device 210, 226 can be of any suitable type, such as a touchscreen, a keypad, a mouse, a trackpad, a joystick, etc. The display device 212, 228 is configured to present user interfaces (e.g., user interfaces associated with the collaborative shopping experience), images (e.g., images of product display units), augmented reality presentations, etc. Accordingly, the display device 212, 228 can of any suitable type, such as a light emitting diode (LED) display device or liquid crystal display (LCD) display device and, in some embodiments, can be integrated with the user input 210, 226 device such as, for example, a touchscreen.

The image recognition server 204 generally identifies products in images (e.g., images of product display units captured by the mobile device 206) and segments the images based on the products. In some embodiments, the image recognition server 204 includes a control circuit 202. The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 202 performs various tasks with respect to the processing of the images. For example, the control circuit 202 can detect products within the images, determine boundaries for the products within the images, segment the image based on the determined boundaries, and associate the sections with the products included in each of the sections. In one embodiment, the control circuit 202 detects the products within the images via image recognition. The image recognition can be based on stored images of products and/or a machine learning model trained with training images (i.e., a machine learning algorithm). Additionally, or alternatively, the control circuit 202 can detect the products based on identifiers included in the image, such as text, computer readable identifiers (e.g., barcodes), etc. In such embodiments, the control circuit 202 can read the identifiers via, for example, optical character recognition, pattern recognition, etc.

After detecting the products in the image, the control circuit 202 determines boundaries for each of the products. The control circuit 202 can determine the boundaries of the products in any suitable manner. As one example, the control circuit 202 can identify the product as it is detected. For example, if detected based on image recognition or a read of an identifier, the control circuit 202 can identify the products. The control circuit 202 can then use the identifications of the products to retrieve product information. For example, the control circuit 202 can retrieve the product information from the item data server 222. In such embodiments, the item data server 222 stores product data for products offered for sale by a retail facility. The product data can include images of the products, prices for the products, inventory information for the products, dimensions for the products, etc. In such embodiments, the control circuit 202 can determine the boundaries for the products based on the dimensions for the products and the locations of the products in the image. As another example, the control circuit 202 can determine the boundaries for the products based on the recognized products. For example, because the control circuit 202 knows what the products are, the control circuit 202 knows what the products looks like and where the products end (i.e., the boundaries of the products). That is, the control circuit 202 has recognized the product via image recognition and thus an determine the boundaries of the product based on the recognized product in the image. As another example, the control circuit 202 may be able to determine the boundaries without identifying the products in the image. For example, gaps (e.g., dark or light spaces) may exist between the products and the gaps may signify the products boundaries, or a variation in colors between adjacent products may indicate the boundaries of the products.

The control circuit 202 next segments the images into sections. The control circuit 202 segments the images based on the boundaries such that one product is in each section. The control circuit 202 associates each of the products included in the images with one of the sections. In this manner, when a customer selects a product (i.e., a location in the image), the product that has been selected can be determined (i.e., based on the location in the image that the customer selected). In one embodiment, the control circuit 202 transmits an indication of the associations between the products and the sections to one or more of the mobile devices 206.

The call handling server 220 facilitates calls between the mobile devices 206. For example, the call handling server 220 can manage the setup and connection of calls, such as video calls and/or voice calls including the transmission of still images. The call handling server 220 can receive call setup requests from the mobile device 206, determine mobile devices 206 to which a call is being made, determine statuses of mobile devices 206, and create and send the messages necessary to process the call requests.

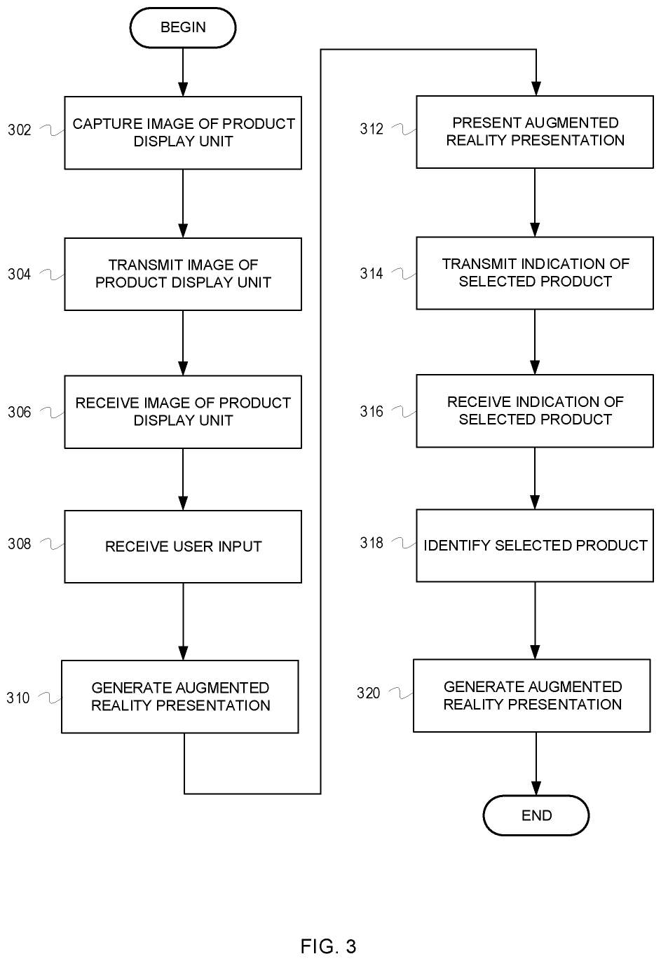

While the discussion of FIG. 2 provides additional detail regarding a system for an augmented reality collaborative shopping experience, the discussion of FIG. 3 describes example operations for an augmented reality collaborative shopping experience.

FIG. 3 is a flow chart depicting example operations for an augmented reality collaborative shopping experience, according to some embodiments. The flow begins at block 302.

At block 302, an image of a product display unit is captured. For example, a mobile device can capture and image of the product display via an image capture device of the mobile device. In one embodiment, an application executing on a mobile device causes the image capture device of the mobile device to capture the image of the product display unit. A first customer located in a retail facility can use the mobile device to capture the image of the product display unit as part of a collaborative shopping experience with one or more other customers that are remote from the retail facility. The image of the product display unit can be a still image and/or a video image (i.e., a video feed). The product display unit contains products. Thus, the image of the product display unit includes at least some of the products contained by (e.g., placed on, supported by, presented by, etc.) the product display unit. The flow continues at block 304.

At block 304, the image of the product display unit is transmitted. For example, the mobile device associated with the first customer (i.e., a first mobile device) can transmit the image of the product display unit to a second mobile device (i.e., a mobile device associated with a second customer). In one embodiment, an application executing on the first mobile device causes the first mobile device to transmit the image of the product display unit to the second mobile device. The first mobile device can transmit the image of the product display unit via a communications network (e.g., a LAN and/or WAN). In some embodiments, a call handling server facilitates the connection, and transfer of the image of the product display unit, from the first mobile device to the second mobile device. The flow continues at block 306.

At block 306, the image of the product display unit is received. For example, the second mobile device can receive the image of the product display unit. In one embodiment, the application (i.e., an instance of the application) executing on the second mobile device can receive the image of the product display unit from the first mobile device. The flow continues at block 308.

At block 308, user input is received. For example, the user input can be received via a user input device of the second mobile device. In one embodiment, the user input is received by the application executing on the mobile device. The user input identifies a selected product. For example, the second customer can provide the user input to identify the selected product from the image of the product display unit. The flow continues at block 310.

At block 310, an augmented reality presentation is generated. For example, the second mobile device can generate the augmented reality presentation (i.e., a second mobile device augmented reality presentation). In one embodiment, the application executing on the second mobile device generates the augmented reality presentation. The augmented reality presentation includes a marker (i.e., a second mobile device marker). The marker denotes the selected product in the image of the product display unit. The flow continues at block 312.

At block 312, the augmented reality presentation is presented. For example, the second mobile device can present the augmented reality presentation (i.e., the second mobile device augmented reality presentation) via a display device of the second mobile device. In one embodiment, the application executing on the mobile device causes presentation of the augmented reality presentation. The flow continues at block 314.

At block 314, an indication of the selected product is transmitted. For example, the second mobile device can transmit the indication of the selected product to the first mobile device. In one embodiment, the application executing on the second mobile device causes the transmission of the indication of the selected product. The indication of the selected product can take any suitable form. For example, the indication of the selected product can include a location on the image of the product display unit. In this example, the location on the image of the product display unit can be used to determine which product included in the image of the product display unit is the selected product. Further, in some embodiments, the image of the product display unit can be segmented into sections, each of the sections being associated with one of the products included in the image of the product display unit. In such embodiments, the indication of the selected product can include an indication of the section that was selected via the user input. The flow continues at block 316.

At block 316, the indication of the selected product is received. For example, the first mobile device can receive the indication of the selected product from the second mobile device. In one embodiment, the application (i.e., instance of the application) executing on the first mobile device receives the indication of the selected product. The flow continues at block 318.

At block 318, the selected product is identified. For example, the first mobile device can identify the selected product based on the indication of the selected product. In one embodiment, the application executing on the first mobile device identifies the selected product. The first mobile device can identify the selected product in any suitable manner. For example, as previously discussed, if the indication of the selected product includes a location on the image of the product display unit, the first mobile device can identify the selected product based on the location on the image of the product display unit. The flow continues at block 320.

At block 320, an augmented reality presentation is generated. For example, the first mobile device can generate an augmented reality presentation (i.e., a first mobile device augmented reality presentation). In one embodiment, the application executing on the first mobile device generates the augmented reality presentation. The augmented reality presentation includes a marker (i.e., a first mobile device marker). The marker denotes the selected product in the image of the product display unit.

While the discussion of FIGS. 1A-3 describes an augmented reality collaborative shopping experience, the discussion of FIGS. 4-6 provides additional detail regarding the selection controls alluded to in the discussion of FIGS. 1A-1C.

FIG. 4 depicts a mobile device 404 presenting information 408 to a customer while shopping, according to some embodiments. The mobile device 404 can be of any suitable type, such as a smartphone, a tablet computer, a personal digital assistant (PDA), a smart watch, etc. The customer uses the mobile device 404 to capture images of products while he or she is shopping in a retail facility. For example, the customer can capture images of a product display unit 402 and/or products 406 located on the product display unit 402. The product display unit 402 can include shelves, hanging baskets, or any other suitable structure for presenting products for sale.

The mobile device 404 generates an augmented reality presentation based on the images captured by the customer. The augmented reality presentation includes at least one image captured by the customer. The image can be a still image (e.g., a digital photograph) and/or a video image. Accordingly, the augmented reality presentation can be based on a still image and/or a video-based augmented reality presentation. In one embodiment, the augmented reality presentation is part of a collaborative shopping experience, as described with respect to FIGS. 1A-3 herein. The augmented reality presentation also includes the information 408. The information 408 can include personalized data for the customer, such as previous purchase information for the customer, the customer's rating for the product, a personalized promotion for the customer, inclusion information for the customer's cart (e.g., a virtual cart), inclusion information for the customer's wish list, suggestion for the customer based on the customers purchase and/or browsing history, etc.

In one embodiment, the augmented reality presentation includes a plurality of selection buttons 412. The selection buttons 412 can be associated with each of the products 406 included in the augmented reality presentation. When the customer selects one of the selection buttons 412, the augmented reality presentation presents the information 408 to the customer. For example, as depicted in FIG. 4, the customer has selected one of the selection buttons 412 associated with a product 410 in the top right of the augmented reality presentation. Because the customer has selected the selection button 412 associated with the product 410, the information 408 presented to the customer is associated with the product 410. For example, as depicted in FIG. 4 the information 408 includes the personalized data that the customer purchased the product 410 last week, is being offered a personalized promotion of 5% off the product 410, and has previously provided a rating of 4.3 for the product 410. It should be noted that, in some embodiments, the information 408 can include information in addition to, or in lieu of, the personalized data. For example, in some embodiments, the information 408 can include information about the product 410, such as a price of the product 410, inventory information for the product 410, dimensions for the product 410, other customer or average customer ratings for the product 410, products that complement the product 410, alternatives to the product 410, etc.

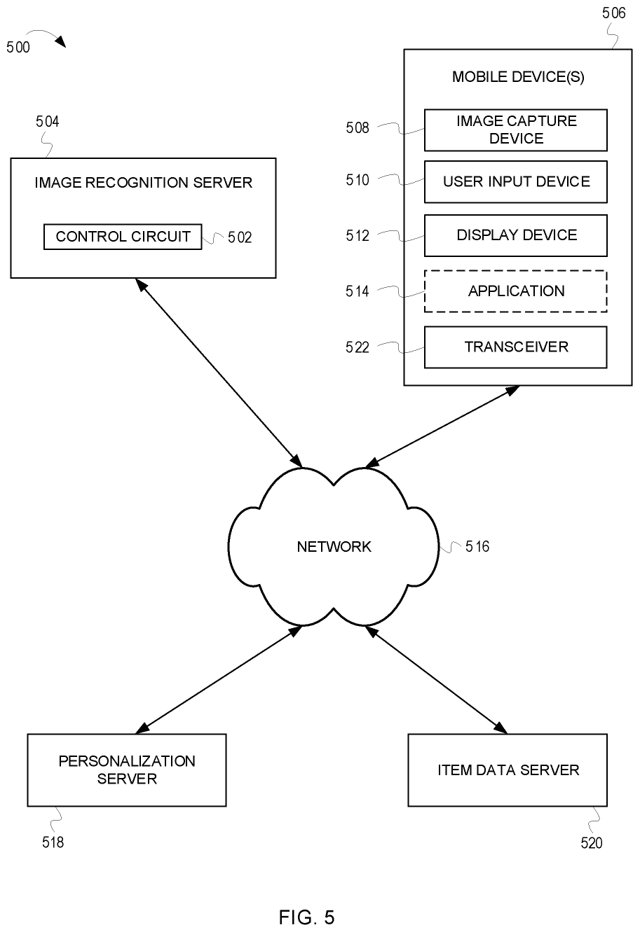

While the discussion of FIG. 4 provides an overview of augmented reality presentations including information for customers, the discussion of FIG. 5 provides additional detail regarding a system for presenting information to customers via an augmented reality presentation.

FIG. 5 is a block diagram of a system 500 for presenting information to customers while shopping., according to some embodiments. The system 500 includes an image recognition server 504, a mobile device 506, a network 516, a personalization server 518, and an item data server 520. One or more of the image recognition server 504, the mobile device 506, personalization server 518, and item data server 520 are communicatively coupled via the network 516. The network 516 can include a local area network (LAN) and/or wide area network (WAN), such as the internet. Accordingly, the network 516 can includes wired and/or wireless links and transmit communications over any suitable protocol.

The mobile device 506 is generally possessed by a customer and can include any number of mobile devices 506. The mobile device 506 can be a smartphone, tablet computer, personal digital assistant, smart watch, etc. The mobile device 506 includes an image capture device 508, a user input device 510, a display device 512, and a transceiver 522. The mobile device 506 is configured to execute an application 514 via, for example a processor. The application 514 can be executed by the mobile device 506 in concert with other software modules or applications (i.e., computer program code), or groups of applications, such as operating systems, locationing applications (e.g., mapping, GPS, etc. applications), two-factor authentication applications (TFA), single sign on (SSO) applications, graphics processing applications, security applications, etc. In one embodiment, the application 514 is an augmented reality application, as described herein. In such embodiments, the application 514 can be a dedicated application (e.g., an application specific to a retailer or to augmented reality presentations) or a general purpose application that, while not a “dedicated application,” can perform the functions described herein with respect to augmented reality presentations. In some embodiments, the application 514 is an add-on application installed on the mobile device 506 and that cooperates with other application(s) of the mobile device 506, such as the operating system and works with other application(s) to provide the functionality described herein. For example, in the embodiment illustrated in FIG. 5, the application 514 communicates with the operating system of the mobile device 506 to control and receive data from at least the display device 512, the user input device 510, and the image capture device 508. The mobile device 506 can store an instance of the application 514 in a memory structure, as described in more detail with respect to FIG. 4. The application 514 can be integrated with, or cooperate, with an operating system of the mobile device 506.

The image capture device 508 is generally configured to capture images of products. The image capture device 508 can be of any suitable type, and include components such as sensors, lens, apertures, etc. The user input device 510 is generally configured to receive user input. For example, the user input device 510 can receive user input selecting products from the image of the products, launching the application 514, making selections from the augmented reality presentation (e.g., of selection buttons), causing the image capture device 508 to capture images, etc. The display device 512 is generally configured to present augmented reality presentations. As discussed previously, the augmented reality presentation can be based on still images and/or video-based. The augmented reality presentation includes images of the products captured by the image capture device 508 as well as information for the products. In some embodiments, the information for the products includes personalized data for the customer associated with the products. The transceiver 522 is generally configured to transmit communications from, and receive communications by, the mobile device 506 (e.g., a communications radio). Accordingly, the transceiver can take any suitable form, and include circuitry and/or software for the transmission and receipt of information via, for example, a cellular network, a Wi-Fi network, a near field communications (NFC) protocol, etc.

The image recognition server 504 generally identifies products in the images (e.g., images of product display units captured by the mobile device 506) and segments the images based on the products. It should be noted, however, that in some embodiments the actions described herein with respect to the image recognition server 504 can be performed by the mobile device 506. That is, in some embodiments, the mobile device 506 can identify the products in the images and segment the images based on the products.

In some embodiments, the image recognition server 504 includes a control circuit 502. The control circuit 502 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 502 is configured (for example, by using corresponding programming as will be well understood by those skilled in the art) to carry out one or more of the steps, actions, and/or functions described herein.

By one optional approach the control circuit 502 operably couples to a memory. The memory may be integral to the control circuit 502 or can be physically discrete (in whole or in part) from the control circuit 502 as desired. This memory can also be local with respect to the control circuit 502 (where, for example, both share a common circuit board, chassis, power supply, and/or housing) or can be partially or wholly remote with respect to the control circuit 502 (where, for example, the memory is physically located in another facility, metropolitan area, or even country as compared to the control circuit 502).

This memory can serve, for example, to non-transitorily store the computer instructions that, when executed by the control circuit 502, cause the control circuit 502 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 502 performs various tasks with respect to the processing of the images. For example, the control circuit 502 can detect products within the images, determine boundaries for the products within the images, segment the image based on the determined boundaries, and associate the sections with the products included in each of the sections. In one embodiment, the control circuit 502 detects the products within the images via image recognition. The image recognition can be based on stored images of products and/or a machine learning model trained with training images. Additionally, or alternatively, the control circuit 502 can detect the products based on identifiers included in the image, such as text, computer readable identifiers (e.g., barcodes), etc. In such embodiments, the control circuit 502 can read the identifiers via, for example, optical character recognition, pattern recognition, etc.

After detecting the products in the image, the control circuit 502 determines boundaries for each of the products. The control circuit 502 can determine the boundaries of the product in any suitable manner. As one example, the control circuit 502 can identify the product as it is detected. For example, if detected based on image recognition or a read of an identifier, the control circuit 502 can identify the products. The control circuit 502 can then use the identifications of the products to retrieve product information. For example, the control circuit 502 can retrieve the product information from the item data server 520. In such embodiments, the item data server 520 stores product data for products offered for sale by a retail facility. The product data can include images of the products, prices for the products, inventory information for the products, dimensions for the products, etc. In such embodiments, the control circuit 502 can determine the boundaries for the products based on the dimensions for the products and the locations of the products in the image. As another example, the control circuit 502 can determine the boundaries for the products based on the recognized products. For example, because the control circuit 502 knows what the products are, the control circuit 502 knows what the products looks like and where the products end (i.e., the boundaries of the products). That is, the control circuit 502 has recognized the product via image recognition and thus an determine the boundaries of the product based on the recognized product in the image. As another example, the control circuit 502 may be able to determine the boundaries without identifying the products in the image. For example, gaps (e.g., dark or light spaces) may exist between the products and the gaps may signify the products boundaries, or a variation in colors between adjacent products may indicate the boundaries of the products.

The control circuit 502 next segments the images into sections. The control circuit 502 segments the images based on the boundaries such that one product is in each section. The control circuit 502 associates each of the products in included in the images with one of the sections. In this manner, when a customer selects a product (i.e., a location in the image), the product that has been selected can be determined (i.e., based on the location in the image that the customer selected). In one embodiment, the control circuit 502 transmits an indication of the associations between the products and the sections to one or more of the mobile devices 506.

The personalization server 518 is generally configured to store personalized data for customers. The personalized data for customers is data that is specific to one or more customers and can include any suitable data. For example, the personalized data can include previous purchase information for the customer, the customer's rating for the product, a personalized promotion for the customer, inclusion information for the customer's cart (e.g., a virtual cart), inclusion information for the customer's wish list, suggestion for the customer based on the customers purchase and/or browsing history, etc. The mobile device 506, or in some embodiments the control circuit 502, transmits an indication of a customer to the personalization server 518. For example, if the user has logged into the application 514 via the user's mobile device 506, the mobile device 506 can pass the log in information to the control circuit 502 and/or the personalization server 518. Additionally, the personalization server 518 receives a product identifier (i.e., an indication of a product) from one or more of the control circuit 502 and the mobile device 506. The personalization server 518 retrieves personalized data for the customer associated with the product based on the received indication of the customer and the product identifier. The personalization server 518 transmits the personalization data for the customer associated with the product to one or more of the control circuit 502 and the mobile device 506.

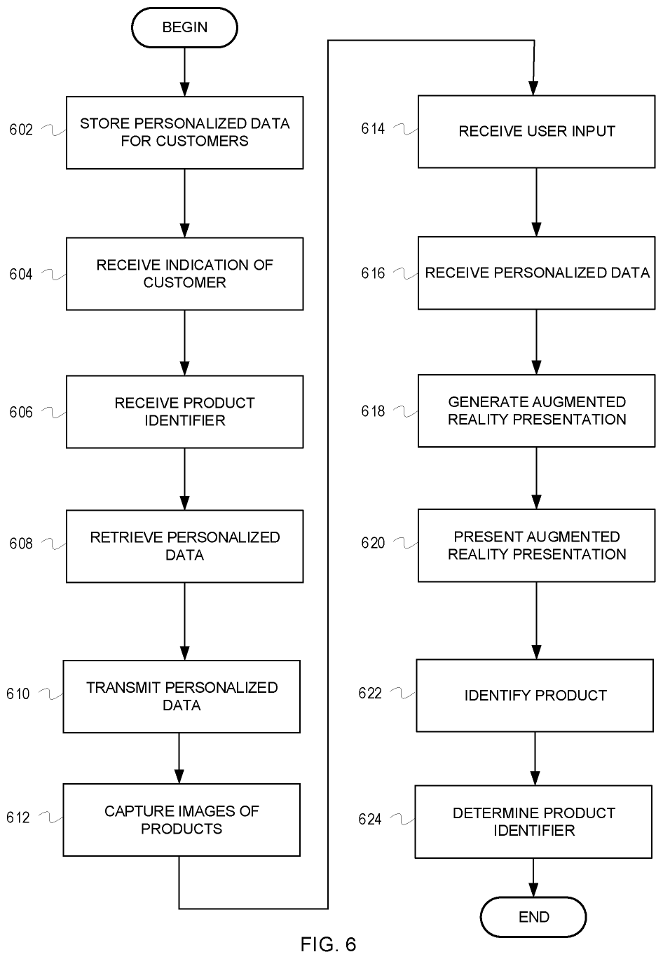

While the discussion of FIG. 5 provides additional detail regarding a system for presenting information to customers via an augmented reality presentation, the discussion of FIG. 6 provides additional detail regarding the operations of such a system.

FIG. 6 is a flow chart depicting example operations for presenting information to customers while shopping, according to some embodiments. The flow begins at block 302.

At block 602, personalized data for customers is stored. For example, a personalization server can store the personalized data for customers. The personalized data can include, for example, previous purchase information for the customer, the customer's rating for the product, a personalized promotion for the customer, inclusion information for the customer's cart (e.g., a virtual cart), inclusion information for the customer's wish list, suggestion for the customer based on the customers purchase and/or browsing history, etc. The flow continues at block 604.

At block 604, an indication of a customer is received. For example, the personalization server can receive the indication of the customer. The indication of the customer can be explicit or implicit. For example, the indication of the customer can be explicit in that it is based on a log in or a customer identifier provided by the customer. The indication of the customer can be implicit, for example, if based on information associated with the customer and used to identify the customer, such as a phone number, a mobile device identifier (e.g., a MAC address), a customer number, etc. The personalization server can receive the indication of the customer from any suitable device, such as a mobile device, an image recognition server, etc. The flow continues at block 606.

At block 606, a product identifier is received. For example, the personalization server can receive the product identifier. The personalization server can receive the product identifier from any suitable device, such as the mobile device, the image recognition server, an item data server, etc. In one embodiment, another component of the system determines the customer identifier. For example, the mobile device, the image recognition server, etc. can detect products in an image captured by the mobile device. The detected products can be identified using any suitable technique, such as image recognition, text recognition, a read of a computer-readable identifier, etc. The flow continues at block 608.

At block 608, personalized data is retrieved. For example, the personalization server can retrieve the personalized data. The personalized data is for a customer and is associated with a product that the customer has selected (i.e., the product identified by the product identifier). The flow continues at block 610.

At block 610, the personalized data is transmitted. For example, the personalized data server can transmit the personalized data to the mobile device and/or the image recognition server. The flow continues at block 612.

At block 612, images of products are captured. For example, the mobile device can capture the images of products. In one embodiment, an application executing on the mobile device causes the mobile device to capture the images of the products. The images of the products can be still images and/or video images. The flow continues at block 314.

At block 614, user input is received. For example, the mobile device can receive user input via a user input device. In one embodiment, the application executing on the mobile device receives the user input. The user input selects a product from the images of the products. For example, if the image is of a product display unit including five products, the use input can select one of the five products. The flow continues at block 316.

At block 616, personalized data is received. For example, the mobile device can receive the personalized data from the personalization server. In one embodiment, the application executing on the mobile device receives the personalized data. The personalized data is for the customer (i.e., is data specific to the customer) and is associated with the selected product. The flow continues at block 618.

At block 618, an augmented reality presentation is generated. For example, the mobile device can generate the augmented reality presentation. In one embodiment, the application executing on the mobile device generates the augmented reality presentation. The augmented reality presentation includes at least one of the images of the products captured by the mobile device and the personalized data for the customer associated with the product. In some embodiments, the augmented reality presentation includes additional selections (e.g., buttons), menus, preferences, etc. For example, the augmented reality presentation can include selection buttons for the products, as well as menus that allow users to navigate information about the products and/or the retail facility. The flow continues at block 620.

At block 620, the augmented reality presentation is presented. For example, the mobile device can present the augmented reality presentation via a display device. In one embodiment, the application executing on the mobile device can cause presentation of the augmented reality presentation. The flow continues at block 622.

At block 622, a product is identified. For example, a control circuit can identify the product. The control circuit can be incorporated with the mobile device, image recognition server, etc. The control circuit can identify the product using any suitable technique. For example, the control circuit can identify the product based on image recognition, identifiers within the image of the products, text recognition, etc. The flow continues at block 624.

At block 624, a product identifier is determined. For example, the control circuit can determine the product identifier. The control circuit can, for example, determine the product identifier from the image of the products and/or by querying an item data server based on the identification of the product.

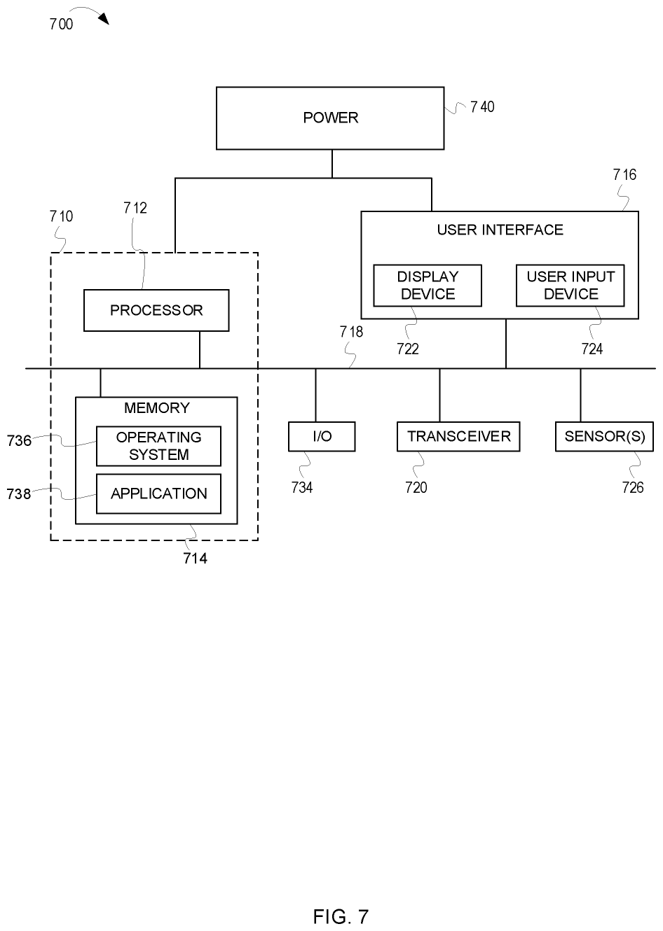

While the discussion of FIGS. 4-6 provides additional detail regarding the operations of a system for presenting information to customers via an augmented reality presentation, the discussion of FIG. 7 provides additional detail regarding mobile devices such as those described herein.

FIG. 7 is a block diagram of an example mobile device 700, according to some embodiments. The mobile device 700 may be used for implementing any of the components, systems, functionality, apparatuses, processes, or devices of the system 200 of FIGS. 2 and 4, and/or other above or below mentioned systems or devices, or parts of such functionality, systems, apparatuses, processes, or devices. The systems, devices, processes, methods, techniques, functionality, services, servers, sources and the like described herein may be utilized, implemented and/or run on many different types of devices and/or systems.

By way of example, the mobile device 700 may comprise a control circuit or processor 712, memory 714, and one or more communication links, paths, buses or the like 718. Some embodiments may include one or more user interfaces 716, and/or one or more internal and/or external power sources or supplies 740. The control circuit can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 712 can be part of control circuitry and/or a control system 710, which may be implemented through one or more processors with access to one or more memory 714 that can store commands, instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the mobile device 700 may be used to implement one or more of the above or below, or parts of, components, circuits, systems, processes and the like.

In one embodiment, the memory 714 stores data and executable code, such as an operating system 736 and an application 738. The application 738 is configured to be executed by the mobile device 700 (e.g., by the processor 712). The application 738 can be a dedicated application (e.g., an application dedicated to collaborative shopping) and/or a general purpose application (e.g., a web browser, a retail application etc.). Additionally, though only a single instance of the application 738 is depicted in FIG. 4, such is not required and the single instance of the application 738 is shown in an effort not to obfuscate the figures. Accordingly, the application 738 is representative of all types of applications resident on the mobile device (e.g., software preinstalled by the manufacturer of the mobile device, software installed by an end user, etc.). In one embodiment, the application 738 operates in concert with the operating system 736 when executed by the processor 712 to cause actions to be performed by the mobile device 700. For example, with respect to the disclosure contained herein, execution of the application 738 by the processor 712 causes the mobile device to perform actions consistent with a collaborative shopping experience as described herein.

The user interface 716 can allow a user to interact with the system 700 and receive information through the system. In some instances, the user interface 716 includes a display device 722 and/or one or more user input device 724, such as buttons, touch screen, track ball, keyboard, mouse, etc., which can be part of or wired or wirelessly coupled with the mobile device 700. Typically, the mobile device 700 further includes one or more communication interfaces, ports, transceivers 720 and the like allowing the mobile device 700 to communicate over a communication bus, a distributed computer and/or communication network (e.g., a local area network (LAN), wide area network (WAN) such as the Internet, etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include one or more input/output (I/O) ports 734 that allow one or more devices to couple with the mobile device 700. The I/O ports can be substantially any relevant port or combinations of ports, such as but not limited to USB, Ethernet, or other such ports. The I/O interface (i.e., I/O ports 734) can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the mobile device 700 may include one or more sensors 726 to provide information to the system and/or sensor information that is communicated to another component, such as the central control system, a delivery vehicle, etc. The sensors 726 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The mobile device 700 comprises an example of a control and/or processor-based system with the control circuit. Again, the control circuit can be implemented through one or more processors, controllers, central processing units, logic, software and the like. Further, in some implementations the control circuit may provide multiprocessor functionality.

The memory 714, which can be accessed by the control circuit, typically includes one or more processor-readable and/or computer-readable media accessed by at least the processor 712, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some or all of the memory 714 can be internal, external or a combination of internal and external memory of the control circuit. The external memory can be substantially any relevant memory such as, but not limited to, solid-state storage devices (SSDs) or drives, hard disk drives (HDDs), one or more of universal serial bus (USB) stick or drive, flash memory secure digital (SD) card, other memory cards, and other such memory or combinations of two or more of such memory, and some or all of the memory may be distributed at multiple locations over a computer network. The memory 714 can store code, software, executables, scripts, data, content, lists, programming, programs, log or history data, user information, customer information, product information, and the like. While FIG. 4 illustrates the various components being coupled together via a bus, it is understood that the various components may actually be coupled to the control circuit and/or one or more other components directly.

Further, it is noted that while FIG. 7 illustrates a generic architecture of the mobile device 700 in some embodiments, this similar architecture can apply to at least the control circuits of FIGS. 2 and 5. For example, the control circuit 202 or 502 could equate to the processor 712 of FIG. 7, and it is understood that the control circuit 202 would likewise be coupled to or have access to one or more of memories, power, user interfaces, I/Os, transceivers, sensors, etc.

In some embodiments, an augmented reality system for collaborative shopping comprises an application configured to be executed by a first mobile device and a second mobile device, the application when executed by the first mobile device causes the first mobile device to perform operations comprising capturing, via an image capture device of the first mobile device, an image of a product display unit, wherein the image of the product display unit includes one or more products, transmitting, via a communications network, the image of the product display unit, the application when executed by the second mobile device causes the second mobile device to perform operations comprising receiving, via the communications network, the image of the product display unit, receiving, via a user input device of the second mobile device, user input, wherein the user input identifies a selected product, and wherein the selected product is one of the one or more products, generating a second mobile device augmented reality presentation, wherein the second mobile device augmented reality presentation includes the image of the product display unit and a second mobile device marker, wherein the second mobile device marker denotes the selected product in the image of the product display unit, presenting, via a display device, the second mobile device augmented reality presentation, and transmitting, via the communications network, an indication of the selected product, wherein the application when executed by the first mobile device causes the first mobile device to perform operations further comprising receiving, via the communications network, the indication of the selected product, identifying, based on the indication of the selected product, the selected product from within the image of the product display unit, and generating a first mobile device augmented reality presentation, wherein the first mobile device augmented reality presentation includes the image of the product display unit and a first mobile device marker, wherein the first mobile device marker denotes the selected product in the image of the product display unit.

In some embodiments, an apparatus, and a corresponding method performed by the apparatus, comprises causing capture, by an application executing on a first mobile device, of an image of a product display unit, wherein the image of the product display unit includes one or more products, causing transmission, by the application executing on the first mobile device via a communications network, the image of the product display unit, receiving, by the application executing on a second mobile device via the communications network, of the image of the product display unit, receiving, by the application executing on the second mobile device, user input, wherein the user input identifies a selected product, and wherein the selected product is one of the one or more products, generating, by the application executing on the second mobile device, a second mobile device augmented reality presentation, wherein the second mobile device augmented reality presentation includes the image of the product display unit and a second mobile device marker, wherein the second mobile device marker denotes the selected product in the image of the product display unit, causing presentation, by the application executing on the second mobile device, of the second mobile device augmented reality presentation, causing transmission, by the application executing on the second mobile device via the communications network, of an indication of the selected product, receiving, by the application executing on the first mobile device via the communications network, the indication of the selected product, identifying, by the application executing on the first mobile device based on the indication of the selected product, the selected product from within the image of the product display unit, and generating, by the application executing on the first mobile device, a first mobile device augmented reality presentation, wherein the first mobile device augmented reality presentation includes the image of the product display unit and a first mobile device marker, wherein the first mobile device marker denotes the selected product in the image of the product display unit.

In some embodiments, an augmented reality system for collaborative shopping comprises an image recognition server, wherein the image recognition server is configured to receive, from a first mobile device, an image of a product display unit, detect, based on the image of the product display unit, one or more products included in the image of the product display unit, determine, within the image of the product display unit, boundaries for each of the one or more products, segment, based on the boundaries for each of the one or more products, the image of the product display unit into sections, associate each of the one or more products with one of the sections, and transmit, to the first mobile device, an indication of the associations between the one or more products and the sections, the first mobile device, wherein the first mobile device comprises an image capture device, wherein the image capture device is configured to capture the image of the product display unit, a user input device, wherein the user input device is configured to receive input from a user, wherein the user input identifies a selected product, wherein the selected product is one of the one or more products included in the image of the product display unit, a display device, wherein the display device is configured to present an augmented reality presentation, wherein the augmented reality presentation includes a first mobile device marker denoting the selected product, and a transceiver, wherein the transceiver is configured to transmit, via a call handling server to a second mobile device, the image of the product display unit, the indication of the associations between the one or more products and the sections, and an indication of the selected product, and the second mobile device, wherein the second mobile device is configured to present the image of the product display unit including a second mobile device marker denoting the selected product.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An augmented reality system for collaborative shopping, the system comprising:
an application configured to be executed by a first mobile device and a second mobile device, the application when executed by the first mobile device causes the first mobile device to perform operations comprising:
capturing, via an image capture device of the first mobile device, an image of a product display unit, wherein the image of the product display unit includes one or more products;
transmitting, via a communications network, the image of the product display unit;
the application when executed by the second mobile device causes the second mobile device to perform operations comprising:
receiving, via the communications network, the image of the product display unit;
receiving, via a user input device of the second mobile device, user input, wherein the user input identifies a selected product, and wherein the selected product is one of the one or more products;
generating a second mobile device augmented reality presentation, wherein the second mobile device augmented reality presentation includes the image of the product display unit and a second mobile device marker, wherein the second mobile device marker denotes the selected product in the image of the product display unit;
presenting, via a display device, the second mobile device augmented reality presentation; and
transmitting, via the communications network, an indication of the selected product;
wherein the application when executed by the first mobile device causes the first mobile device to perform operations further comprising:
receiving, via the communications network, the indication of the selected product; identifying, based on the indication of the selected product, the selected product from within the image of the product display unit; and
generating a first mobile device augmented reality presentation, wherein the first mobile device augmented reality presentation includes the image of the product display unit and a first mobile device marker, wherein the first mobile device marker denotes the selected product in the image of the product display unit.

2. The augmented reality system of claim 1, wherein the indication of the selected product includes a location within the image of the product display unit.

3. The augmented reality system of claim 1, wherein the first mobile device marker is a first color and the second mobile device marker is a second color.

4. The augmented reality system of claim 1, further comprising:
an image recognition server, wherein the image recognition server is configured to:
receive, from the first mobile device, the image of the product display unit;
detect, based on the image of the product display unit, the one or more products included in the image of the product display unit;
determine, within the image of the product display unit, boundaries for each of the one or more products;
segment, based on the boundaries for each of the one or more products, the image of the product display unit into sections;
associate each of the one or more products with one of the sections; and
transmit, to the first mobile device, an indication of the associations between the one or more products and the sections;
wherein the application when executing on the first mobile device causes the first mobile device to perform operations further comprising:
transmitting the indication of the of the associations between the one or more products and the sections to the second mobile device with the image of the product display unit.

5. The augmented reality system of claim 4, wherein the image recognition server determines the boundaries for each of the one or more products based on a machine learning algorithm.

6. The augmented reality system of claim 4, wherein the indication of the selected product includes an indication of one of the sections.

7. The augmented reality system of claim 1, further comprising:
a call handling server, wherein the call handling server is configured to:
initiate a video call between the first mobile device and second mobile device; and
transmit, between the first mobile device and the second mobile device, images captured by the first mobile device and selections received via user input at one or more of the first mobile device and the second mobile device.

8. The augmented reality system of claim 1, wherein the image of the product display unit is part of a video feed captured by the first mobile device.

9. The augmented reality system of claim 1, wherein the application when executed by the first mobile device further causes the first mobile device to perform operations comprising:
receiving user input selecting a second product from the one or more products;
transmitting, for presentation on the second mobile device, an indication of the second product; and
updating the first augmented reality presentation to include a marker denoting the second product.

10. A method for collaborative shopping, the method comprising:
causing capture, by an application executing on a first mobile device, of an image of a product display unit, wherein the image of the product display unit includes one or more products;
causing transmission, by the application executing on the first mobile device via a communications network, the image of the product display unit;
receiving, by the application executing on a second mobile device via the communications network, of the image of the product display unit;
receiving, by the application executing on the second mobile device, user input, wherein the user input identifies a selected product, and wherein the selected product is one of the one or more products;
generating, by the application executing on the second mobile device, a second mobile device augmented reality presentation, wherein the second mobile device augmented reality presentation includes the image of the product display unit and a second mobile device marker, wherein the second mobile device marker denotes the selected product in the image of the product display unit;
causing presentation, by the application executing on the second mobile device, of the second mobile device augmented reality presentation;
causing transmission, by the application executing on the second mobile device via the communications network, of an indication of the selected product;
receiving, by the application executing on the first mobile device via the communications network, the indication of the selected product;
identifying, by the application executing on the first mobile device based on the indication of the selected product, the selected product from within the image of the product display unit; and
generating, by the application executing on the first mobile device, a first mobile device augmented reality presentation, wherein the first mobile device augmented reality presentation includes the image of the product display unit and a first mobile device marker, wherein the first mobile device marker denotes the selected product in the image of the product display unit.

11. The method of claim 10, wherein the indication of the selected product includes a location within the image of the product display unit.

12. The method of claim 10, wherein the first mobile device marker is a first color and the second mobile device marker is a second color.

13. The method of claim 10, further comprising:
receiving, by an image recognition server from the first mobile device, the image of the product display unit;
detecting, by the image recognition server based on the image of the product display unit, the one or more products included in the image of the product display unit;
determining, by the image recognition server within the image of the product display unit, boundaries for each of the one or more products;
segmenting, by the image recognition server based on the boundaries for each of the one or more products, the image of the product display unit into sections;
associating, by the image recognition server, each of the one or more products with one of the sections; and
transmitting, by the image recognition server via the communications network, an indication of the associated between the one or more products and the sections;
wherein the application executing on the first mobile device causes transmission of the indication of the associations between the one or more products and the sections to the second mobile device with the image of the product display unit.

14. The method of claim 13, wherein the image recognition server determines the boundaries for each of the one or more products based on a machine learning algorithm.

15. The method of claim 13, wherein the indication of the selected product includes an indication of one of the sections.

16. The method of claim 10, further comprising:
initiating, by a call handling server, a video call between the first mobile device and the second mobile device; and
transmitting, by the call handling server between the first mobile device and the second mobile device via the communications network, images captures by the first mobile device and selections received via user input at one or more of the first mobile device and the second mobile device.

17. The method of claim 10, wherein the image of the product display unit is part of a video feed captured by the first mobile device.

18. The method of claim 10, further comprising:
receiving, by the application executing on the first mobile device, user input selecting a second product from the one or more products;
causing transmission, by the application executing on the first mobile device over the communications network, of an indication of the second product; and
updating, by the application executing on the first mobile device, the first segmented reality presentation to include a marker denoting the second product.

19. An augmented reality system for collaborative shopping, the system comprising:
an image recognition server, wherein the image recognition server is configured to:
receive, from a first mobile device, an image of a product display unit;
detect, based on the image of the product display unit, one or more products included in the image of the product display unit;
determine, within the image of the product display unit, boundaries for each of the one or more products;
segment, based on the boundaries for each of the one or more products, the image of the product display unit into sections;
associate each of the one or more products with one of the sections; and
transmit, to the first mobile device, an indication of the associations between the one or more products and the sections;
the first mobile device, wherein the first mobile device comprises:
an image capture device, wherein the image capture device is configured to capture the image of the product display unit;
a user input device, wherein the user input device is configured to receive input from a user, wherein the user input identifies a selected product, wherein the selected product is one of the one or more products included in the image of the product display unit;
a display device, wherein the display device is configured to present an augmented reality presentation, wherein the augmented reality presentation includes a first mobile device marker denoting the selected product; and
a transceiver, wherein the transceiver is configured to transmit, via a call handling server to a second mobile device, the image of the product display unit, the indication of the associations between the one or more products and the sections, and an indication of the selected product; and
the second mobile device, wherein the second mobile device is configured to present the image of the product display unit including a second mobile device marker denoting the selected product.

20. The augmented reality system of claim 19, wherein the image of the product display unit is part of a video feed captured by the first mobile device.
